(19) United States
(12) Patent Application Publication
(10) Pub. No.: US 2002/0134147 A1
(43) Pub. Date: Sep. 26, 2002

(54) On-board dynamometer

(76) Inventors: Gerard Leon Janelle, Punta Gorda, FL (US); Theodore Paul VonFeldt II, Coconut Creek, FL (US)

Correspondence Address: GERARD L. JANELLE, c/o JANELLE ENGINEERING, INC, 128 HERALD COURT, PUNTA GORDA, FL, 33950, US

(21) Appl. No.: 09/817,503

(22) Filed: Mar. 26, 2001

(51) Int. Cl. G01L 3/26

(52) U.S. Cl. 73/116

(57) ABSTRACT

An apparatus for measuring the performance of a vehicle or vessel's rotary drive while underway. The system includes a strain gage to “sense” torque on the driveline or propeller shaft and the use of telemetry to communicate this measurement to a microprocessor. The system also includes tachometers to measure rotational speeds and global positioning system for determining the vehicle or vessel's speed and heading. All data is acquired by the microprocessor, which in turn calculates the shaft horsepower and communicates the calculated as well as the acquired data to an operator display and/or a computer database. The system is in wireless communication with an Internet website designed to acquire the data and display it as a real-time event.

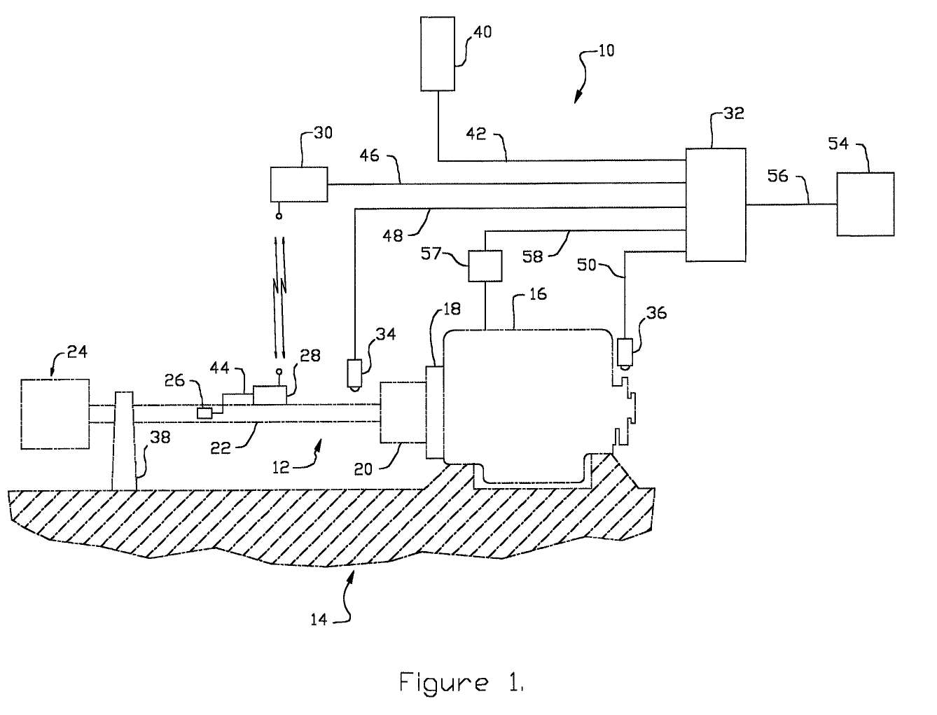

### BACKGROUND OF THE INVENTION

(1) Field of the Invention

This invention relates generally to equipment used for testing and/or monitoring the performance of a rotary drive system, primarily but not limited to an internal combustion engine and associated driveline components.

(2) Description of the Prior Art

During the engine manufacturing process, internal combustion engines are final tested in a factory test cell with a dynamometer directly mounted to the rotating shaft of the test engine. This is known to be the standard procedure used by all engine builders to verify engine performance.

Once the engine has been installed in a vehicle, verification of performance requires that the engine first be removed from the vehicle and delivered to a facility equipped with a similar test cell. A less expensive approach utilizes a chassis dynamometer. This procedure requires that the vehicle be delivered to a facility where it is driven onto sets of rollers. Coupled to the rollers is an adjustable brake capable of inducing a resistance in the rollers. A dynamometer of sufficient size is coupled to the brake to verify the power generated by the vehicle during operation.

The present invention overcomes the need for engine removal and a test facility, and has neither power nor vehicle weight constraints. The drive shaft power measurement is taken during an actual vehicle road test hence no simulation of resistance is required.

Similarly, dynamometer verification of inboard marine and aircraft engine performance necessitates the removal of the engine from the vessel, delivering it to a test facility and placing it in a dynamometer test cell. Consequently, a less expensive on-board engine test is the preferred method. This method was previously limited to the recording of engine fuel and temperature measurements at various engine speeds while under way and comparing the results to the engine manufacturer's original data.

The present invention provides a more accurate means of verifying engine performance by instantaneously measuring the actual shaft torque and it's rotational speed in order to continuously display the horsepower generated by the vessels engine(s) while underway.

### SUMMARY OF THE INVENTION

Accordingly, a first object of this invention is to provide an on-board dynamometer for verifying engine horsepower while underway.

Another object of this invention is to provide a diagnostic tool for checking the condition of an installed engine while underway.

Another object of this invention is to provide an on-board engine horsepower monitoring system.

Yet another object of the invention is to provide a horsepower display at the operator control station for monitoring engine performance while underway.

Still another object of this invention is to verify the engine's transmission ratio by comparing two tachometers, the purpose being to detect possible clutch slippage while under load.

Another object of this invention is to provide clutch slippage indication on the operator display.

A further object of this invention is to provide a record of engine performance by storing the acquired data in a computer file. This allows the data to be replayed for future analysis.

Still another object of this invention is to generate relational data by acquiring the vehicle or vessel's global positioning information and comparing it to the acquired engine performance data.

Another object of this invention is to communication with an Internet website designed to acquire the data and display it as a real-time event.

Lastly, another object of this invention is to provide an on-board dynamometer capable of supplying the necessary mechanical data for conducting Transient FTP engine emissions testing or any other emission testing that requires monitoring or recording engine performance under load.

In view of these objects, the instant invention provides an apparatus for measuring the performance of a vehicle or vessel's rotary drive system while underway. The system comprises a strain gage attached to a driveline or propeller shaft and the use of telemetry to communicate the strain gage data to a microprocessor. The system also includes two tachometers to measure the rotational speed of the shaft and the rotary drive and a global positioning system for determining vessel or vehicle speed and heading. All data is acquired by the microprocessor, which in turn calculates the shaft horsepower and communicates the results to an operator display, a computer database and an Internet website.

### BRIEF DESCRIPTION OF THE DRAWING

A more complete understanding of the invention and many of the attendant advantages thereto will be readily appreciated as the same become better understood by reference to the following detailed description when considered in conjunction with the accompanying drawing which illustrates a schematic elevational view of an on-board dynamometer of the present invention.

The FIGURE provides a side view of the current invention.

### DETAILED DESCRIPTION OF THE PREFERRED EMBODIMENT

Referring now to the drawing figure, there is generally indicated at 10 an on-board dynamometer of the present invention for measuring the performance of the internal combustion engine installation generally indicated at 12 shown as mounted on the vehicle or vessel generally indicated at 14. The on-board dynamometer 10 is a low cost, non-invasive horsepower measuring system that can be easily installed on the vehicle or vessel's drive components and can travel with the vehicle or vessel 14 thus eliminating the need for any additional braking device to absorb or simulate a load.

The engine installation generally indicated at 12 consists of the engine 16, which transmits power by engagement of the clutch 18, and the gear box 20 to the driver shaft 22 and ultimately to the driven load generally indicated at 24. The driven load 24 is supported by truss 38 and is further defined as a propeller, wheel or any such device that is capable of converting the torsional forces of driver shaft 22 to the thrust force required to move the vehicle or vessel 14.

The on-board dynamometer generally indicated at 10 includes a strain gage 26 bonded to the driver shaft 22. When the engine 16 is under load, torsional distortion on the driver shaft 22 causes a change in electrical resistance of the strain gage 26 proportional to the applied torque. The digital radio telemetry transmitter 28 mounted on the driver shaft 22 and in electrical communication with the strain gage 26 via line 44, rotates with the strain gage 26 on the driver shaft 22, measures the electrical resistance and transmits a data signal via radio telemetry to the receiver 30 which is mounted adjacent to the driver shaft 22. The receiver 30 is in electrical communication with the microprocessor 32 via line 46. A shaft tachometer 34 is disposed on or adjacent to the driver shaft 22 to sense the rotational speed of the driver shaft 22 and is in electrical communication with the microprocessor 32 via line 48. An engine tachometer 36 is disposed on or adjacent to the engine 16 to sense the engine 16 rotational speed and is also in electrical communication with the microprocessor 32 via line 50.

The microprocessor 32 contains the necessary software to read the torque signal from the receiver 30 and the rotational speed signals from the shaft tachometer 34 and the engine tachometer 36. On the basis of these input signals, the microprocessor calculates the shaft horsepower achieved.

The global positioning system 40 tracks the velocity and heading of the vehicle or vessel and is in electrical communication with the microprocessor 32 via line 42.

In addition, the microprocessor has the necessary software to compare the ratio of the two RPMs to that of the gear box 20. Any difference in the ratios can be attributed to a slippage or a disengagement of the clutch 18.

The microprocessor 32 can be chosen from any of the well-known computers, which are designed for data acquisition, storage, display and wireless Internet connectivity. The software can be manipulated and changed for varying system characteristics, such as driver shaft geometry and various shaft material properties. The following is used for calculating the horsepower of driver shaft 22:

Shaft Horsepower=Shaft Torque×Shaft RPM/5252 (1)

where

Shaft Torque=foot-pounds (2)

where

Shaft RPM=revolutions per minute (3)

Further provided is a display module 54 located at the control station of the vehicle or vessel 14. The display module 54 is in electrical communication with the microprocessor 32 via line 56 and continuously displays the measured data.

While there is shown and described herein certain specific structure embodying the invention, it will be manifest to those skilled in the art that various modifications and rearrangements of the parts may be made without departing from the spirit and scope of the particular forms herein shown and insofar as indicated by the scope of the appended claims:

What is claimed is:

1. An on-board dynamometer for measuring the horsepower of a vehicle or vessel's rotary drive while underway comprising:
a strain gage bonded to the drive shaft and in electrical communication with a radio telemetry transmitter;
a radio telemetry transmitter mounted on the drive shaft and in radio communication with a receiver;
a radio telemetry receiver mounted adjacent to the drive shaft;
a shaft tachometer disposed on or adjacent to the drive shaft;
an engine tachometer disposed on or adjacent to the engine;
a global positioning system;
a microprocessor in electrical communication with the radio telemetry receiver, the shaft tachometer, the engine tachometer and the global positioning system;
an operator display module located at the operator control station.

2. The on-board dynamometer as set forth in claim 1, said radio telemetry transmitter comprising a means for measuring the electrical resistance of said strain gage and converting the resulting data to a voltage level representing torque.

3. The on-board dynamometer as set forth in claim 1, said microprocessor comprising the means for acquiring the torque data from said radio telemetry receiver, the shaft speed data from said shaft tachometer, the engine speed data from said engine tachometer and the vehicle or vessel's speed and heading from said global positioning system.

4. The on-board dynamometer as set forth in claim 3 said microprocessor further comprising the means to calculate the driver shaft horsepower as the result of said torque data and said shaft speed data.

5. The on-board dynamometer as set forth in claim 1, said microprocessor still further comprising the means to calculate the ratio of said shaft tachometer to said engine tachometer signals.

6. The on-board dynamometer as set forth in claim 1, said microprocessor comprising a means for wireless communication with an Internet website and database.

7. The on-board dynamometer as set forth in claim 1, said operator display module in electrical communication with said microprocessor.
